(19) United States
(12) Patent Application Publication
(10) Pub. No.: US 2017/0039595 A1
(43) Pub. Date: Feb. 9, 2017

(54) INSERTION OF AD-SONG ADVERTISEMENTS

(71) Applicant: iHeartMedia Management Services, Inc., San Antonio, TX (US)

(72) Inventors: Michael Lincoln Albl, Cincinnati, OH (US); David C. Jellison, JR., Ogallala, NE (US); Nigel Attwell, Goldens Bridge, NY (US)

(73) Assignee: iHeartMedia Management Services, Inc., San Antonio, TX (US)

(21) Appl. No.: 15/296,249

(22) Filed: Oct. 18, 2016

Related U.S. Application Data
(62) Division of application No. 14/853,401, filed on Sep. 14, 2015.
Application No. 14/853,401 is a continuation-in-part of application No. 12/917,596, filed on Nov. 2, 2010.
Application No. 12/917,596 is a continuation-in-part of application No. 13/850,912, filed on Mar. 26, 2013, now Pat. No. 9,135,061.
Application No. 13/850,912 is a continuation of application No. 12/856,952, filed on Aug. 16, 2010, now Pat. No. 8,418,182.

(51) Int. Cl. G06Q 30/02; G06F 17/30

(52) U.S. Cl. CPC G06Q 30/0264; G06F 17/30053; G06F 17/30743

(57) ABSTRACT

A media programming log is evaluated, and a determination is made that the media programming log includes an ad song scheduled for broadcast within a proximity threshold of a commercial set. The ad song is associated with an advertiser. An evaluation of spot inventory associated with the commercial set is performed, and a determination is made that at least one spot in the commercial set can be used for insertion of an ad-song advertisement. The ad-song advertisement contains at least a portion of a version of the ad song. The ad-song advertisement can then be inserted into at least one spot of a broadcast log, which can be delivered to an audio server for broadcast.

### CROSS-REFERENCE TO RELATED APPLICATIONS

The present U.S. Utility patent application claims priority pursuant to 35 U.S.C. §121 as a divisional of U.S. Utility application Ser. No. 14/853,401, entitled “TRIGGERED CONTENT MODIFICATION,” filed Sep. 14, 2015, which claims priority pursuant to 35 U.S.C. §120 as a continuation-in-part of U.S. Utility application Ser. No. 12/917,596, entitled “RULES BASED PLAYLIST GENERATION”, filed Nov. 2, 2010, both of which are hereby incorporated herein by reference in their entirety and made part of the present U.S. Utility patent application for all purposes.

U.S. Utility application Ser. No. 14/853,401 also claims priority pursuant to 35 U.S.C. §120 as a continuation-in-part of U.S. Utility application Ser. No. 13/850,912, entitled “METHOD AND SYSTEM FOR CONTROLLING A SCHEDULING ORDER PER CATEGORY IN A MUSIC SCHEDULING SYSTEM”, filed Mar. 26, 2013, now U.S. Pat. No. 9,135,061, which is a continuation of U.S. Utility application Ser. No. 12/856,952, entitled “METHOD AND SYSTEM FOR CONTROLLING A SCHEDULING ORDER PER CATEGORY IN A MUSIC SCHEDULING SYSTEM,” filed Aug. 16, 2010, now U.S. Pat. No. 8,418,182, all of which are hereby incorporated herein by reference in their entirety and made part of the present U.S. Utility patent application for all purposes.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field

The present disclosure relates generally to automated or semi-automated scheduling, delivery and playout of multimedia content, and more particularly to triggering modification of media content scheduled to be delivered via any of multiple different media platforms.

2. Description of Related Art

In some instances, advertisers use music to create an audio brand profile with consumers. Whether it is a specific song or a series of songs, the advertiser desires the audio branding to be incorporated to impact various consumer touch points in advertising, at events and in stores. In general, advertisers would like to have their advertisements positioned so that their audio brand benefits from the playout of particular songs.

Conventional automated media scheduling techniques usually schedule advertisements based on market statistics and demographics associated with a block of time, such as a daypart, on one or more specified stations. For example, an advertiser can request an advertisement to be scheduled for broadcast on a selected radio station during a selected daypart because that daypart on that radio station might have a listener base that corresponds to the advertiser's target market. The advertiser's order can be provided to an automated scheduling system, which then inserts an advertisement in available spot inventory (empty advertising slots) during the requested daypart. However, conventional automated scheduling systems may not account for specific songs that will be scheduled for playout during the selected daypart. Additionally, conventional systems often schedule content for playout without taking into account advertising content scheduled in particular spot blocks (groups of advertising slots).

Advertisers may also prefer their advertisements to be scheduled so that advertised products and services are presented to consumers in a favorable context. For example, an advertiser marketing a vegetable that has been engineered to ripen at a slower than normal rate after being picked may not want their advertisement played in conjunction with a discussion about the undesirability of genetically modified organisms. Current automated media scheduling systems, however, are unable to take into account a current context in which an advertisement is being delivered. This shortcoming arises, in part, from the inability of current systems to actually know the current context, either because the context is unknown at the time an advertisement is scheduled, or because the context changes after the advertisement has been scheduled.

It is apparent, in view of the above discussion, that currently available automated media scheduling systems are less than perfect.

### BRIEF SUMMARY

The present disclosure is directed to apparatus and methods of operation that are further described in the following Brief Description of the Drawings, Detailed Description, and Claims. Various features and advantages of the present invention will become apparent from the following detailed description made with reference to the accompanying drawings.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a block diagram illustrating an automated media processing system according to various embodiments of the present disclosure;

FIG. 2 is a flowchart illustrating a method of inserting triggered content according to various embodiments of the present disclosure;

FIG. 3 is a flowchart illustrating a method of inserting triggered content across media platforms, according to various embodiments of the present disclosure;

FIGS. 4A-4B are flowcharts illustrating a method of modifying a media schedule to include an ad-song advertisement, according to various embodiments of the present disclosure;

FIG. 5 illustrates a schematic view of a data-processing system, in accordance with the disclosed embodiments;

FIG. 6 illustrates a schematic view of a software system including an operating system, application software, and a user interface, in accordance with the disclosed embodiments;

FIG. 7 illustrates a flow chart of operations depicting logical operational steps of a method for controlling a scheduling order per category, in accordance with the disclosed embodiments;

FIG. 8 illustrates an example of a graphically displayed table which may be utilized to configure settings for controlling a multimedia schedule, in accordance with the disclosed embodiments;

FIG. 9 illustrates an example of a graphically displayed table which may be utilized to configure settings for controlling a multimedia schedule, in accordance with the disclosed embodiments;

FIG. 10A illustrates an example of a multimedia programming rotation with evenly-spaced multimedia plays throughout a programming day, in accordance with the disclosed embodiments;

FIG. 10B illustrates an example of a graphically displayed table showing the three songs scheduled to be played in a pre-programmed countdown show, in accordance with the disclosed embodiments;

FIG. 10C illustrates an example of a graphically displayed table used for scheduling the remaining time slots throughout the day, in accordance with the disclosed embodiments;

FIG. 10D illustrates an example of a graphically displayed table used for in which a reverse scheduling method is used to solve scheduling problems, in accordance with the disclosed embodiments;

FIG. 10E illustrates an example of a graphically displayed table used for scheduling a time slot range in regular chronological order, in accordance with the disclosed embodiments; and

FIG. 10F illustrates an example of a graphically displayed table used for scheduling a time slot range in reverse chronological order, in accordance with the disclosed embodiments.

### DETAILED DESCRIPTION

The following is a detailed description of various embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In various embodiments, triggered content can be broadcast, streamed, displayed, or otherwise presented to consumers in response to identifying triggering content by evaluating a media programming log, or by performing an analysis of content that is currently being, or has recently been, broadcast, streamed, or otherwise provided to consumers. The triggered content need not be presented on the same media platform used to detect the triggering content.

For example, an advertiser can place an advertising buy for a terrestrial, online, or mobile media provider, such as a radio station, and request ads to be run adjacent to, or within a certain time period prior to or after, an “ad song” is played. An automated media scheduling system can evaluate a media programming log to determine if the ad-song is scheduled to be played within a proximity threshold of a commercial set. The proximity threshold can be set by the advertiser or by the automated media scheduling system.

The automated media scheduling system can also evaluate a traffic log, which includes information about spot inventory, to determine if there is room in that commercial set to insert an ad-song advertisement, or whether a currently scheduled advertisement in the commercial set can be replaced by an ad-song advertisement. If so, the ad-song advertisement can be scheduled for play in the commercial set. In some implementations, a current advertisement can be replaced by the ad-song advertisement, thereby assisting the advertiser to enhance its audio brand profile with consumers.

In other embodiments, an advertiser can place an advertising buy that specifies placement, removal, or replacement of a general advertisement with a specific advertisement related to a topic or event. For example, the content of a talk show can be evaluated during its broadcast to identify a topic being discussed. Any discussion about a topic of interest or an event of interest can trigger an automated media scheduling system to modify a commercial set within a proximity threshold of the discussion, e.g. a commercial set scheduled during or immediately after the talk show, to fulfill the advertiser's request.

In yet other embodiments, information associated with newscasts, weather reports, or substantially real-time listener statistics can trigger the automated media scheduling system to attempt to place, remove, replace, a media item, or alter a frequency with which various commercial and non-commercial media items are presented to consumer.

As used herein, the term “triggered content” refers generally to content scheduled by an automated media scheduler for delivery to a consumer in response to detection of triggering content. Triggered content includes, but is not limited to: an advertisement including any portion of an ad-song; a media item including commercial content associated with a particular song or video item, a media item including commercial content associated with a particular version of song or video item, a media item including a recording of at least part of the triggering content; a media item including specific content used to replace another media item including more generalized content; radio data system (RDS) content; a web site wrapper; a web site banner, artwork displayed on mobile devices or Internet browsers, application skins, emojis, a sign display, or the like.

“Triggering content,” as that term is used herein, refers to media content that causes, or triggers, an automated media scheduling system to attempt to schedule or modify a pre-existing schedule by adding or removing media content from the schedule, replacing scheduled media content with other media content, changing a scheduled frequency of scheduled media playout, or recording the triggering content to create or modify media content to be inserted into a media schedule. Triggering content can include, but is not limited to a specific song (e.g. an ad song) or group of songs, a specific version of a song, specific portions of audio, video, or multimedia content; media content associated with a specific topic or group of topics, media content associated with a specific event, phrases presented in a media broadcast or stream that indicate occurrence of a particular event or related to a designated topic. Triggering content can be presented obtained from a terrestrial radio or streaming radio station; an on-line media station including multi-cast and streaming radio, television, and mixed media stations; a website or mobile application; or “outdoor” information, such as information displayed or scheduled to be displayed on an electronic billboard or another display, either outside or inside, and used to “visually broadcast” media content.

The term “ad song” is used herein to refer to a song, or a version of that song, which is part of an advertiser's branding campaign. For example, Jeep® and Sprite® have used the Imagine Dragons song, “I Bet My Life” in various advertisements. “I Bet My Life” is an example of an ad song.

Term “ad-song advertisement” refers to an advertisement that includes at least part of an ad song, or some version of the ad song. Jeep and Sprite advertisements including all or part of the song, “I Bet My Life” are examples of ad-song advertisements. In some embodiments, an ad-song advertisement can include a version of the ad song that has been adapted specifically for inclusion in the ad-song advertisement.

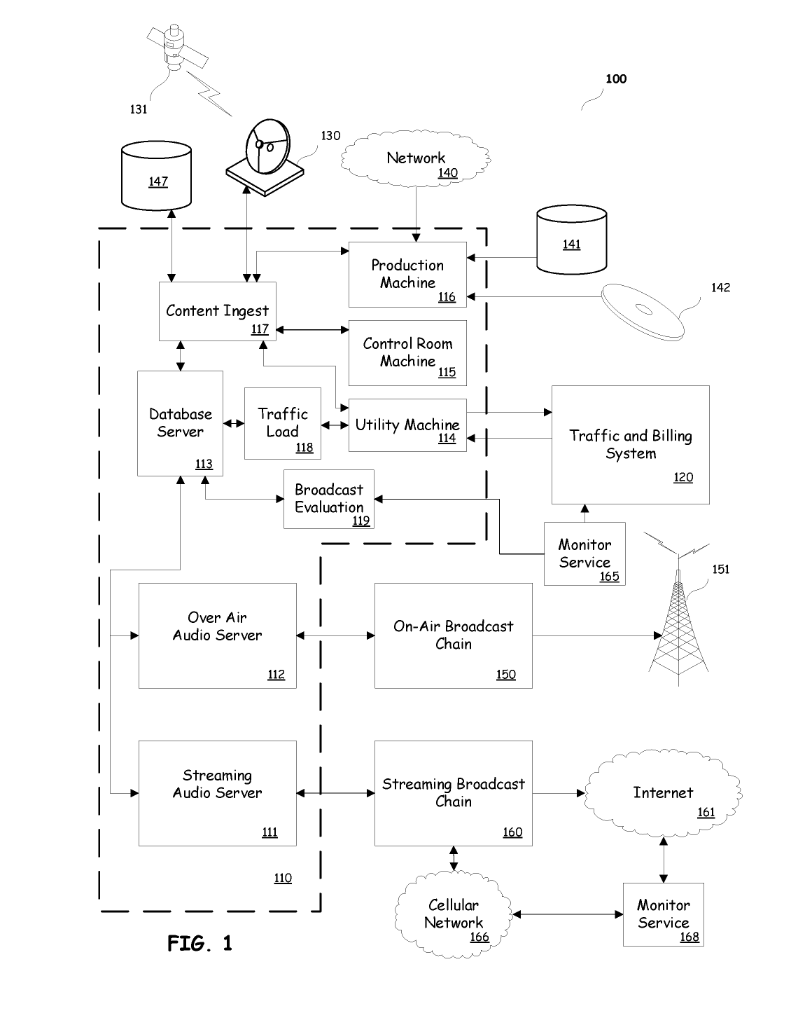

Referring first to FIG. 1, a system 100 according to various embodiments of the present disclosure will be discussed. System 100 includes media automation system 110, which can be used to control and automate various media broadcast and scheduling functions, including the generation and modification of playlists; traffic and billing system 120, which can be used to provide control for various traffic and billing functions such as entering and editing orders, and scheduling spots; and monitor service 165, which can be used to deliver information about actually broadcast content to traffic and billing system 120 and to media automation system 110. System 100 also includes streaming broadcast chain 160, through which a streaming broadcast of media content can be provided to cloud based services such as iHeart Radio® (not illustrated), networks such as Internet 161 and cellular network 166 for delivery to mobile device 168, on air broadcast chain 150, through which media content can be broadcast via a broadcast tower 151, and various media sources such as an individual source media 142, bulk media storage 141, programming from another market received via network 140, and programming broadcast via satellite 131, which can be received via satellite receiver 130. In various embodiments, system 100 also includes database 147, which can be used to store one or more versions of various media rating charts, non-commercial media content, commercial media content such as ad-song advertisements, and lists or tables, for example a list of ad songs, which can be used in generating and modifying playlists, media programming logs, and commercial logs according to some embodiments.

Media automation system 110 includes production machine 116, which receives media content from network 140, bulk media storage 141, individual source media 142, control room machine 115, and utility machine 114, each of which is connected to content ingest module 117, which is used to receive content and provide ingested content to database server 113. Note that content ingest module 117 can be implemented in a stand-alone server machine, as part of database server 113, or otherwise. Utility machine 114, as illustrated, can be connected between traffic load module 118 and traffic and billing system 120 to provide traffic logs and other information to database server 113, and to provide information related to replaced, added, removed, and substituted media items to traffic and billing system 120. Traffic load module 118 can be implemented as a stand-alone server machine, as part of database server 113, or otherwise. Media automation system 110 can, in some embodiments, include broadcast evaluation module 119, which receives information about actually-broadcast media content from monitor service 165. The information about actually-broadcast media content can include, but is not limited to, recordings, transcripts, summaries, push-now-playing messages, or other information indicating content actually broadcast via broadcast tower 151 and Internet 161.

Media automation system 110 also includes media playout systems, including Over-Air audio server 112 to provide media content to on air broadcast chain 150, and streaming audio server 111 to provide audio content to streaming broadcast chain 160. Playlists generated by Database server 113, Production Machine 116, Control Room Machine 115, or Utility Machine 114 can be provided by Database server 113 to one or more playout systems including either or both of Over-Air audio server 112 and streaming audio server 111. In at least one embodiment, one or more of the illustrated servers can be implemented as a virtual server on the same hardware as another of the illustrated servers. Furthermore, various distributed processing techniques can be used to spread functionality of one or more of the illustrated servers across multiple different hardware components.

Traffic and billing system 120 can provide media automation system 110 with information about advertiser orders, as well as traffic logs that can be used by database server 113 to evaluate commercial sets and determine whether one or more spots in the commercial set are available to be used for insertion of an ad-song advertisement, or other triggered content. Database server 113 also generates media programming logs based on information received from content ingest module 117, or receives media programming logs from production machine 116, control room machine 115, or utility machine 114. In at least some embodiments, the media programming logs can be generated and maintained separately from traffic logs or spot inventory logs, even when combined broadcast logs are delivered to Over-Air audio server 112 or audio server 111. In other embodiments, database server 113 can separate a single log into separate media programming and a commercial/spot logs, or operate on a combined media programming log and commercial/spot log.

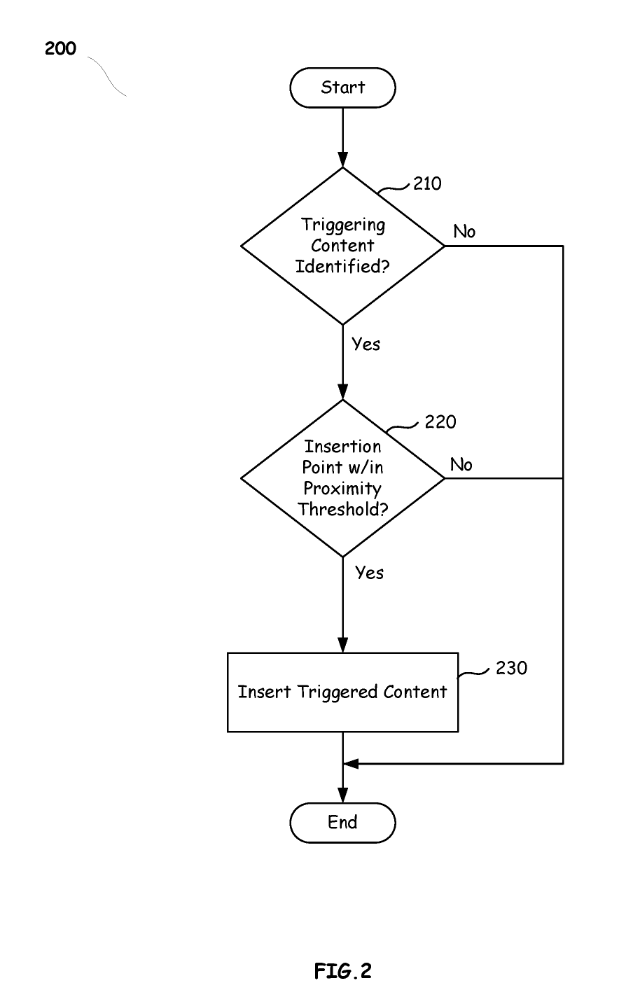

Referring next to FIG. 2, a method 200 of inserting triggered content will be discussed according to various embodiments of the present disclosure. Method 200 begins at block 210, where triggering content is identified. Identifying triggering content can include inspecting or evaluating a media programming log, which identifies media content and the time the media content is scheduled to be broadcast, aired, or otherwise played out. The media programming log can also include blocks of time reserved for commercial content such as advertisements, and referred to herein as spot blocks or commercial sets. In at least some embodiments, database server 113 or another processing device included in an automated media scheduling system such as system 100, can compare media content items specified in the media programming log with a list of triggering content to determine whether the media programming log includes triggering content. In some embodiments, triggering content is identified by comparing metadata or tags associated with individual media items included in the media programming log to determine whether any of the songs in the media programming log are considered to be triggering content.

In other embodiments, for example where triggering content is associated with specific topics or events, one or more media platforms can be monitored by an automated media scheduling system or monitoring service for phrases, images, or other content associated with selected topics or events. Phrases, images, or other content obtained as a result of the monitoring can be compared to a collection of pre-determined phrases or images, and the results of the comparison can be used to determine whether or not a topic of interest is being discussed, or whether an event of interest has occurred. In some implementations, for example, a weather report, a news report, or real-time data obtained from, for example, Nielsen PPM® (Portable People Meter) can be used to identify the occurrence of an event or to help identify content of interest. If the phrase, image, or other content obtained from any or all of these sources is related to a topic of interest, the phrase, image or other content can be considered to be triggering content, because the presence of that content will trigger an attempt to place triggered content.

If no triggering content is identified at block 210, method 200 ends. If triggering content is identified at block 210, a check is made to determine whether there is an insertion point within a proximity threshold of the triggering content, as illustrated by block 220.

In some embodiments, the proximity threshold is a period of time before or after a spot block or commercial set, as indicated by a media programming log. Even though a media programming log may not identify the content of the commercial set, start and end times of the commercial set can be determined by evaluating a commercial log in some embodiments. Periods of time specified by a proximity threshold can include different period before and after the commercial set. So, for example, one or more proximity thresholds can be used to designate limit placement of triggered content into commercial sets within a window that begins 5 minutes before the triggering content is scheduled to play and ends 1 minute after the triggering content is scheduled to play.

In some embodiments a proximity threshold can be specified based on a number of media items. For example, the proximity threshold can specify a “distance” of 1 media item, indicating that there should be no more than 1 media item between the insertion point and the triggering content. Similarly, a distance of “0” can indicate that the insertion point should be immediately adjacent to the triggering content, a distance of 2 can indicate that there should be no more than 2 media items between the insertion point and the triggering content, and so forth. Various combinations of time periods and “distance” can be used, in addition to other factors. For example, an advertiser could specify a proximity threshold having a distance of 1, a time of 3 minutes and 15 seconds, and further specify that the insertion point cannot be in a different daypart than the triggering content. In some embodiments, if any or all of these conditions are not satisfied, the insertion point fails to satisfy the proximity threshold requirement.

In various embodiments, a time of occurrence can be associated with trigger content, which can be used for example, to help account for delays in identifying triggering content. Such delays may be caused by network or device latency, processing time required to record, transcribe, summarize, or otherwise process information obtained from one or more media platforms. In at least some embodiments, the time at which the triggering content was originally provided to a consumer can be associated with the triggering content, and a proximity threshold can be evaluated based on whether or not an insertion point is available within a maximum time after the triggering content was broadcast. Assume, for example, that triggering content associated with a desired topic is broadcast during a talk show at 7:01 am, and that it takes 5 minutes for the automated media scheduling system to determine whether or not the content of the talk show is, in fact, triggering content. This delay can be a result of the processing time required to analyze the broadcast, extract phrases from the broadcast content, and compare the extracted phrases to a list of phrases indicating a topic of interest. If the next commercial set is scheduled for 7:09 am, and the proximity threshold for the triggered content associated with the topic is set to 15 minutes, then the commercial set can be said to fall within the proximity threshold, or to satisfy the proximity threshold.

If there is no potential insertion point within the proximity threshold, method 200 ends. If an insertion point within the proximity threshold is identified, insertion of triggered content can be performed, as illustrated at block 230. In various embodiments, insertion of triggered content includes inserting a more specific commercial or non-commercial media item into a broadcast or other log in place of a corresponding general, or less specific content item, e.g. replacing a non ad-song advertisement with an ad-song advertisement.

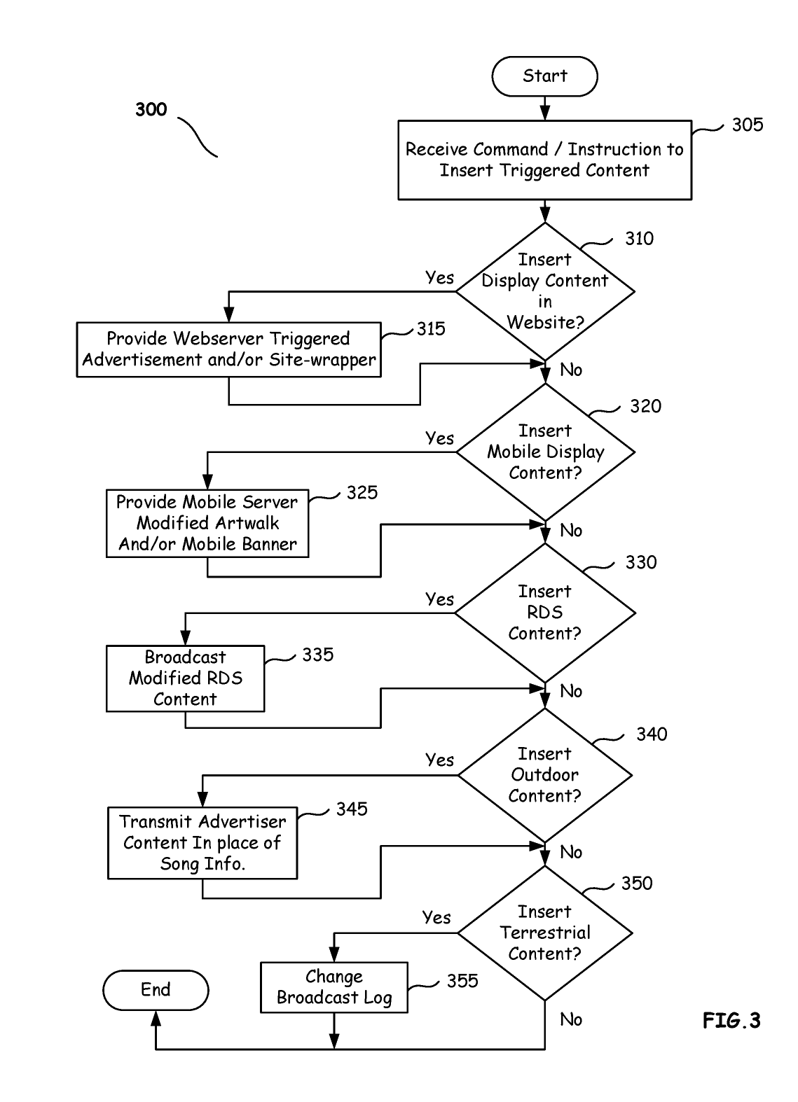

Referring next to FIG. 3, a method 300 of inserting triggered content across media platforms will be discussed according to various embodiments of the present disclosure. Method 300 begins by receiving or executing a command or instruction to insert triggered content, as illustrated by block 305. In some embodiments, the instruction is generated and received or executed by a single device, for example a database server included in an automated media scheduling system, such as media automation system 110 (FIG. 1).

As illustrated by block 310, a check is made to determine whether the triggered content is to be delivered for display in a website. A determination about whether to display triggered content in a website can be made. This decision can be based on, for example, information received from an advertiser during an advertising buy, advertiser preferences, market campaign parameters, or the like. For example, an advertiser may specify that its commercial message, the triggered content, is not to be presented on one or more websites, but may optionally be presented on one or more other websites. Alternatively or additionally, market campaign preferences can indicate that triggered content is to be presented exclusively on websites.

In some embodiments, advertiser buy information, preferences, or other information can indicate that an advertiser's triggered content is to be presented exclusively on the same media platform as the triggering content, or that some or all of the advertiser's triggered content is permitted to be delivered via one or more of the following media platforms: websites, mobile displays, RDS, “outdoor” platforms such as signs, terrestrial broadcasts. Other media platforms or combinations of media platforms can also be specified, and particular triggered content can restrict to delivery via specific media platforms. The determination made at block 310 can also include checking for a proximity threshold, which may be different for different media platforms, and can also be based on other considerations, such as how recently or how frequently the same triggered content has been presented on a particular media platform, on a particular station, or to a particular user.

If it is determined at block 310 that the triggered content is to be delivered via a website or Internet radio, method 300 proceeds to block 315, where the triggered content is provided to a webserver or a streaming broadcast chain for delivery to a network user. In at least some embodiments, triggered content can be a visual media element, such as a site-wrapper, banner advertisement, or the like. In other embodiments, the triggered content can be a media item including audio content, such as an ad-song advertisement.

In various embodiments, triggering content can be detected on one media platform, and triggered content can be delivered to another media platform. For example, the occurrence of an event of interest to an advertiser can be inferred by monitoring a terrestrial radio broadcast to detect one or more phrases or combinations of phrases associated with an event of interest. Even though in this example the triggering content, e.g. the detected phrase, is obtained via a first media platform, i.e. a terrestrial radio broadcast, the triggered content can be delivered via a second media platform i.e. a website.

In some embodiments, regardless of whether the triggered content is to be delivered via a website, method 300 proceeds to block 320. As illustrated at block 320, a check is made to determine whether to insert the triggered content as mobile display content. If the determination at block 320 indicates that the triggered content is to be delivered to a mobile display, method 300 proceeds to block 325. As illustrated at block, 325, the triggered content is delivered to a server device configured to provide information to mobile devices. Providing the triggered content to the mobile server can include transmitting the triggered content to a streaming broadcast chain, which can in turn forward the triggered content to a mobile provider's network such as a cellular network. The triggered content can include modified artwork or a mobile banner. For example, an advertiser's logo can be presented in combination with, or in lieu of, one or more other visual elements delivered to the mobile device.

As illustrated at block 330, a determination can be made about whether providing the triggered content includes modifying RDS content delivered to an RDS capable radio. The decision made at block 330 can be based, at least in part on a proximity threshold, whether appropriate RDS content is available, whether an advertiser has specified providing the RDS content, or the like. In some embodiments, a proximity threshold associated with RDS content can, but need not, be limited to occur during presentation of the triggering content. If the determination at block 330 indicates that RDS content is to be delivered as the triggered content, the RDS content delivered via a terrestrial radio broadcast can be modified to present, for example, an advertiser's name or slogan can be broadcast in place of a song name or an artist name, as illustrated at block 335.

As illustrated by block 340, a check can be made to determine if triggered content is to be presented as “outdoor” content. As used herein, the term “outdoor” refers to a particular media platform involving signs, not the location of the media presentation device. Thus, for example, although many signs and billboards are located outside, the term “outdoor” also includes signs located inside of buildings. As illustrated at block 345, if the triggered content is to be delivered as “outdoor” content, advertiser content can be delivered in place of other content normally displayed on one or more signs. For example, media information such as media title or author can be replaced by advertiser content.

As illustrated at block 350, a check can be made to determine if the triggered content is to be delivered as terrestrial content. If so, a broadcast log can be modified to include the triggered content. Method 300 ends after either block 350 or 355.

The following use-cases provide examples of various embodiments implemented in accordance with the principles set forth herein. These examples, while not explicitly illustrated, employ techniques disclosed in conjunction with the various embodiments discussed herein.

### Examples

### Event and/or Content Trigged Audio Playback

Advertisers and broadcasters, collectively “users,” can provide information identifying specific topics, or a range of topics or events to an automated media scheduling system, or to a traffic and billing system in conjunction with a commercial buy or otherwise. The information provided by the user to the traffic and billing system can include a list of pre-determined phrases to match for particular topics or events, or other information that can be used construct or obtain such a list. The user can, but need not, specify particular advertisements to be placed in conjunction with particular topics or events of interest. The traffic and billing system, in various embodiments, forwards or otherwise provides some or all of the information identifying topics or events to an automated media scheduling system, such as media automation system 110 which can monitor audio content from one or more media platforms for the pre-determined phrases or events.

Should the pre-determined phrases or events be detected by the media automation system, or by a monitoring service used by the media automation system, and if system parameters related to playback, such as a proximity threshold for example, are satisfied, an advertisement for the user can be presented as specified by content adjustment parameters associated with different content triggers, or otherwise. In some embodiments, the content adjustment parameters can specify that a general message associated with the user is to be triggered, while in other embodiments the content adjustment parameter can specify that a message including specific content is triggered. In various embodiments, the content adjustment parameters can also or alternatively include information indicating which media channel is to be used to deliver triggered content.

The triggered content can be delivered to consumers via fully integrated content playback and display over multiple media platforms and consumer touch points. In various embodiments, content adjustment parameters can be used to indicate which media channel is to be used to deliver triggered content. In some embodiments, content adjustment parameters can include system parameters, which can be used to specify an action to take in response to identifying triggering content. For example, a content adjustment parameter can be used to indicate that triggering content should result in adding triggered content, removing previously scheduled content, increasing the frequency of playback of a designated message for a time period, reducing the frequency of playback of a designated message for a time period, or triggering some combination of these actions.
a. Example: Topic is “civil unrest.” One of many phrases of interest to a particular advertiser may be “concealed carry classes”. The automated media scheduling system, or a monitoring service providing information to the automated media scheduling system, can recognize the phrase from a new program, and schedule an advertisement for concealed carry classes during the next commercial break. Simultaneously, an RDS message can be changed to mention an advertiser offering concealed carry classes. Real time outdoor messages, online mobile application banner ads, and website advertising can also be modified to include information about the advertiser offering concealed carry classes.
b. Example: Topic is “automotive technology.” The subject of autonomous cars is being discussed on a talk show. The automated media scheduling system, or a monitoring service providing information to the automated media scheduling system, can recognize the phrase “self-driving cars.” The automated media scheduling system can infer from the triggering content, “self-driving cars,” that the subject of “automotive technology” is being discussed. The system can compare a listing that links advertisers with requested topics to determine which advertisers have indicated that they want to have their advertisements aired when automotive technology is being discussed. Car sales ads can appear adjacent to content, or can replace previously scheduled advertisements for advertisers who have either expressed no preference, or who have expressed a negative preference for the topic of automotive technology.
c. Example: A negative event associated with Company X is being discussed. The automated media scheduling system, or a monitoring service providing information to the automated media scheduling system, can recognize a sequence of phrases associated with the negative event, such as “Company X,” “liable,” and “compensate.” The automated media scheduling system can infer from the sequence of phrases that the negative event is being discussed. Company X has indicated that when a negative discussion regarding Company X occurs, a specific positive public relations message should be played to counter the negative content. The automated media scheduling system can select the specific positive public relations message from a collection of public relations messages based on the specific sequence of phrases.
d. Example: Cincinnati Reds win or lose baseball game. Triggering content can include a newsfeed accessed by an automated media scheduling system, and based on the triggering content, the occurrence of the event can be inferred, determined, or confirmed. In response to determining that the event occurred, triggered content can be provided in place of previously scheduled content for a designated period of time. The previously scheduled content may have been a generalized message related to baseball, but the triggered content references the Reds' win or loss. For example, radio station promos can be changed from generalized messages related to the Reds, to triggered content promos stating, “Reds Win” or “Reds Lose.” The triggered content can be scheduled to air for a specified period of time, for example until the next game's start time. Concurrently, advertisers' message content can be changed from general to event inclusion in advertising. For example, the previously scheduled content can say, “Buy a car from advertiser X,” while the triggered content says, “You can win like the Reds when you buy a car from advertiser X.”
e. Example: Weather report or Emergency Alert indicates severe storms, floods and Tornado in Dallas. The automated media scheduling system obtains triggering content from a newscast or from an Emergency Alert System (EAS) alert. The media automation system can access a list of advertisers and their associated preferences to determine that Battery company has indicated an interest in promoting batteries and flashlights during severe weather conditions. The automated media scheduling system also determines that an Emergency Prep company wants to promote their survival food prep products during severe weather events. Based on these determinations, the automated media scheduling system schedules or immediate inserts triggered content for Battery company and Emergency Prep company. Concurrently, the radio station has indicated to the automated media scheduling system severe weather alerts will trigger a change in the promos being aired for the station, and station content changes to promote listener safety tips, which may include advertiser sponsorships, in on-air, online, mobile, and outdoor media platforms.
f. Example: Nielsen PPM real time data indicates a sudden shift from indoor location use to outdoor location use. The media automation system recognizes the shift based on the triggering content (PPM data), and changes commercial advertising messages and/or station promos to reflect outside activities. Amusement Water Park ads, which may have stopped running while the PPM data indicated more indoor use than outdoor use, are now are triggered by Nielsen PPM data or other triggering content that indicates people are now active outside.

### Examples

### Content Insertion into Audio Playback

Advertisers and broadcasters, collectively “users,” can provide preference information to a traffic and billing system or an automated media scheduling system. The preference information can include content adjustment parameters indicates that in response to triggering information indicating a specific topic or a range of topics or events, the user wants to capture content, and insert the captured content into a playback message, such as an advertisement or a promo. In at least one embodiment, an automated media scheduling system can be provided with a “shell” advertisement or promo, and can automatically insert the captured content into the shell.
a. Example: Talent is discussing Presidential race. During an interview, a presidential candidate speaks a phrase selected as triggering content by an opposition candidate. The automated media scheduling system can capture, or record, the content including the phrase, and construct a playback event using the captured content. The automated media scheduling system can then use the newly created event as triggered content to be played in response to other triggering content. For example, Candidate A says Gun Control is needed. The system captures the statement by Candidate A, and inserts the captured content into a donut shell provided by Candidate B. The newly created political ad for Candidate B can be scheduled to air, with the message that Candidate B is for gun rights and Candidate A is not.
b. Example: A series of songs play in the last 30 minutes on a radio station, and several of the songs are performed by artists who will appear at the iHeart® Radio Music Festival (IHRMF). The automated media scheduling system recognizes the artists and the specific songs, and creates a promo on fly for IHRMF using these artists and either the songs recently played, or more relevant songs. The system pieces together pre-created elements to construct a full promo that includes at least some of the triggering content. For example, the triggering content can be inserted into a promo with pre-recorded elements as follows: Intro—Artist mention—Artist song hook (from triggering content)—Artist mention—Artist song hook (from triggering content)—IHRMF content—Artist mention—Artist song hook (from triggering content)—Close.

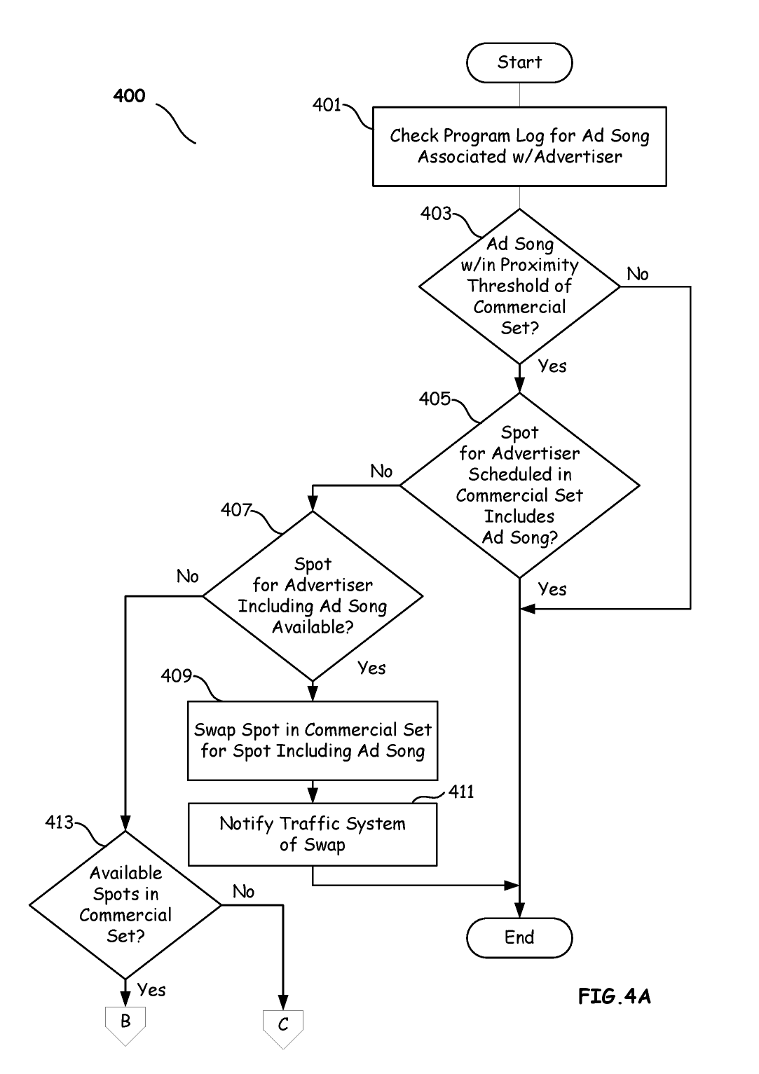

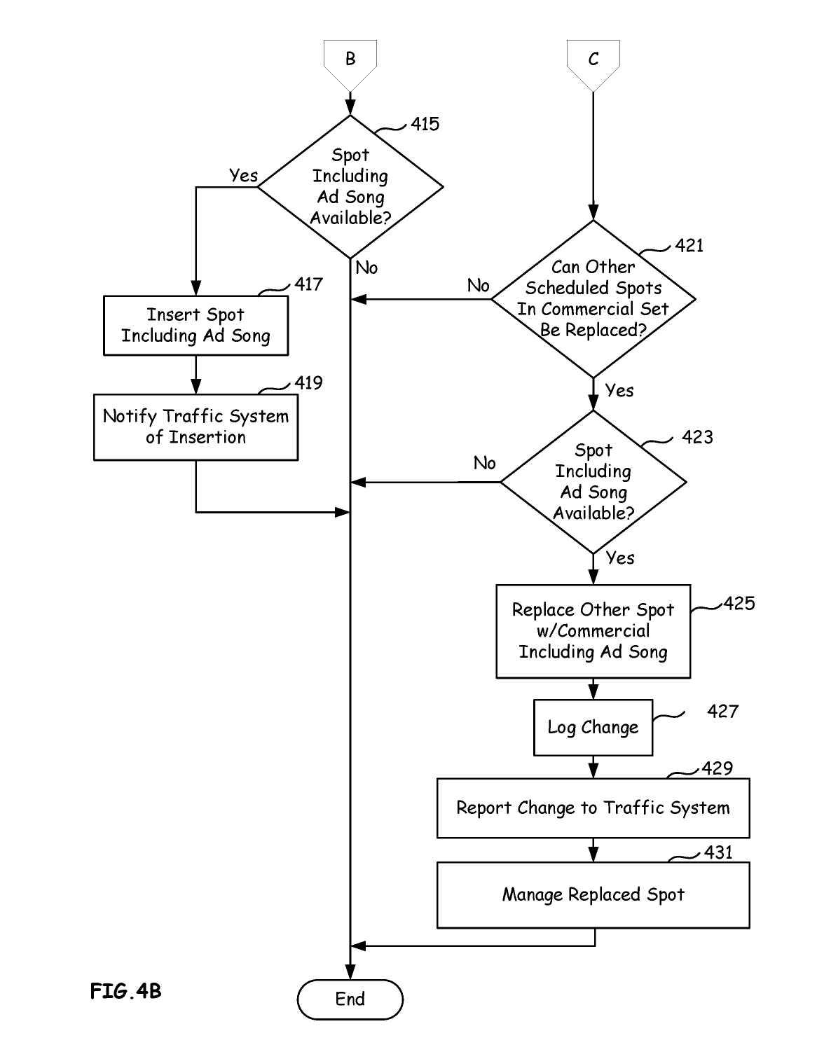

Referring next to FIG. 4A-4B, a method 400 of modifying a media schedule to include an ad-song advertisement will be discussed according to various embodiments of the present disclosure. Method 400 begins at block 401, where a media program log is checked for the presence to an ad song associated with an advertiser. As illustrated by block 403, a check is made to determine if the ad song is within a proximity threshold of a commercial set. In various embodiments the commercial set, or spot block, can be either prior to or subsequent to the identified ad song, depending on the proximity threshold and in some cases other advertiser preferences and system parameters. If there is no ad song within the proximity threshold of a commercial set, as determined at block 403, method 400 ends

As illustrated at block 405, if there is a commercial set within the proximity threshold of the ad song, a check can be made of a spot inventory, as indicated by a traffic log, to determine if the identified commercial set already includes an ad-song advertisement from the same advertiser. If an evaluation of the spot inventory indicates that the commercial set already includes an ad-song advertisement for the advertiser associated with the ad song, no change to the media schedule is required, because there is already an ad-song advertisement scheduled for play within a proximity threshold of the ad song, and method 400 ends.

As illustrated at block 407, if the commercial set being evaluated does not already include an ad-song advertisement for the advertiser associated with the ad song, a check can be made to determine if there is another, non-ad-song advertisement scheduled for playout in the commercial set. If the advertiser has another, non-ad song advertisement scheduled in the commercial set, the advertiser's non-ad song advertisement can be replaced by the advertiser's ad-song advertisement, as illustrated at block 409. As illustrated by block 411, after swapping out the non-ad-song advertisement for the ad-song advertisement, the traffic system is notified so that the traffic system can update the traffic log.

If the advertiser associated with the ad song does not have an advertisement scheduled in the commercial set, a check can be made to determine if there are any available, or not-yet scheduled, spots in the commercial set that can be used for an ad-song advertisement, as illustrated by block 413. If there are available spots, a check can be made to determine whether there is an available ad-song advertisement, as illustrated by block 415. If not, method 400 ends. If there is an available ad-song advertisement to put in the available spot of the commercial set, the spot including the ad song (i.e. the ad-song advertisement) is inserted into the available spot within the commercial set, as illustrated by block 417, and the traffic system is notified as illustrated by block 419.

If it is determined at block 413 that the commercial set does not include any available spots, a check is made at block 421 to determine if there are previously scheduled advertisements in the commercial set that can be replaced. If not, method 400 ends. If there are spots already scheduled in the commercial set that can be replaced, a check is made at block 423 to determine whether there is an appropriate ad-song advertisement for the advertiser that can be used as a replacement. If not, method 400 ends.

If there is an available ad-song advertisement, the previously scheduled spot is replaced by the ad-song advertisement, as illustrated by block 425, as illustrated at block 427, the automated media scheduling system logs the change at block 427, and reports the change to the traffic system as shown at block 429. As illustrated at block 431, the automated media scheduling system or the traffic system manages the replaced spot by placing it into a bumped spot pool, attempting to reschedule the spot using various methods known to those of skill in the art.

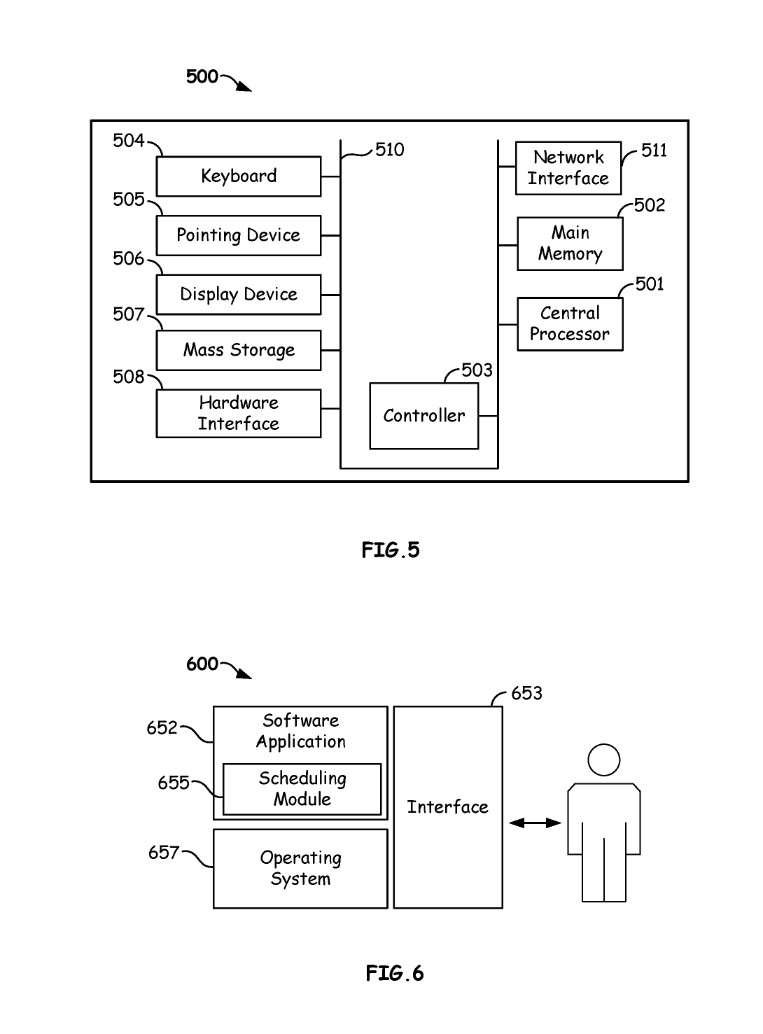

FIGS. 5-6 are provided as exemplary diagrams of a data processing environment in which embodiments may be implemented. It should be appreciated that FIGS. 5-6 are only exemplary and are not intended to assert or imply any limitation with regard to the environments in which aspects or embodiments of the invention may be implemented. Many modifications to the depicted environments may be made without departing from the spirit and scope of the present invention.

As illustrated in FIG. 5, the disclosed embodiments may be implemented in the context of a data-processing system 500, which can be configured to include, for example, a central processor 501, a main memory 502, an input/output controller 503, a keyboard 504, a pointing device 505 (e.g., mouse, track ball, pen device, or the like), a display device 506, and a mass storage 507 (e.g., hard disk). Additional input/output components, such as a hardware interface 508, and network interface 511 for example, may be electronically connected to the data-processing system 500 as desired. Hardware interface 508 may constitute, for example, a USB (Universal Serial Bus) that allows other devices, such as printers, fax machines, scanners, copiers, and so on, to be communicated with the data-processing system 500. Network interface 511 can include wired, wireless, or both wired and wireless interfaces configured to communicate via packet switched or analog networks using any of various communication protocols.

Note that as illustrated, the various components of the data-processing system 500 communicate through a system bus 510 or similar architecture. It can be appreciated that the data-processing system 500 may in some embodiments, be implemented as a mobile computing device such as a Smartphone, laptop computer, Apple®, iPhone®, etc. In other embodiments, data-processing system 500 may function as a desktop computer, server, and the like, depending upon design considerations. Various computing devices and portions of system 100 (FIG. 1), can be implemented as a data-processing system like data-processing system 500.

FIG. 6 illustrates a computer software system 600 for directing the operation of the data-processing system 500 depicted in FIG. 5. Software application 652, stored in main memory 502 and on mass storage 507, includes a kernel or operating system 657 and a shell or interface 653. One or more application programs, such as software application 652, may be “loaded” (i.e., transferred from mass storage 507 into the main memory 502) for execution by the data-processing system 500. The data-processing system 500 receives user commands and data through interface 653; these inputs may then be acted upon by the data-processing system 500 in accordance with instructions from operating system 657 and/or software application 652.

Note that the term module as utilized herein may refer to a collection of routines and data structures that perform a particular task or implement a particular abstract data type. Modules may be composed of two parts: an interface, which lists the constants, data types, variable, and routines that can be accessed by other modules or routines, and an implementation, which is typically private (accessible only to that module) and which includes a source code that actually implements the routines in the module. The term module may also simply refer to an application, such as a computer program design to assist in the performance of a specific task, such as word processing, accounting, inventory management, music program scheduling, etc.

Generally, program modules include routines, programs, objects, components, data structures, etc., that perform particular tasks or implement particular abstract data types. Moreover, those skilled in the art will appreciate that the disclosed method and system may be practiced with other computer system configurations, such as, for example, hand-held devices, multi-processor systems, microprocessor-based or programmable consumer electronics, networked PCs, minicomputers, mainframe computers, and the like.

The interface 653, which is preferably a graphical user interface (GUI), also serves to display results, whereupon the user may supply additional inputs or terminate the session. In an embodiment, operating system 657 and interface 653 can be implemented in the context of a “Windows” system. It can be appreciated, of course, that other types of systems are potential. For example, rather than a traditional “Windows” system, other operation systems, such as, for example, Linux may also be employed with respect to operating system 657 and interface 653. The software application 652 can include a scheduling module 655 that can be adapted to control scheduling with respect to the delivery and airplay of multimedia content, as described in greater detail herein. The software application 652 can also be configured to communicate with the interface 653 and various components and other modules and features as described herein. Scheduling module 655, in particular, can implement instructions for carrying out, for example, the methods 200, 300, 400, and 700 depicted in FIGS. 2-4 and 7, and/or additional operations as described herein.

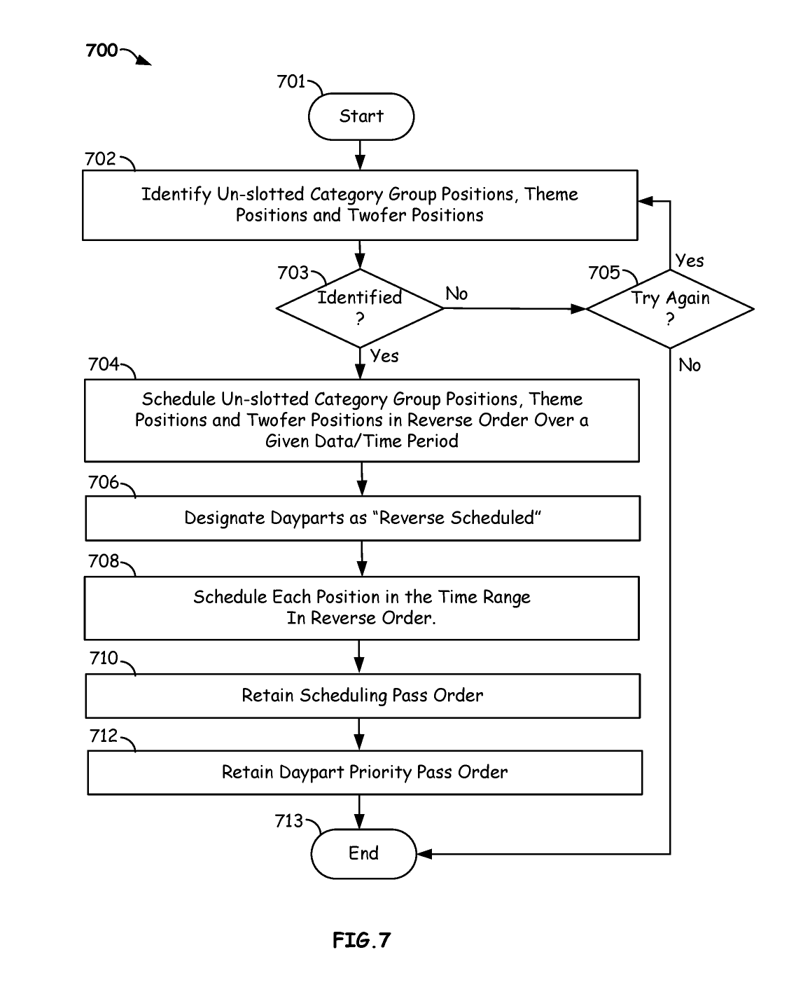

FIG. 7 illustrates a flow chart of operations depicting logical operational steps of a method 700 for controlling a scheduling order per category, in accordance with the disclosed embodiments. The method 700 offers the ability to control a scheduling order and set such a scheduling order either as a forward order per category or a reverse order per category, and can be used in conjunction with methods 200, 300, and 400, described previously. For example, when determining whether a commercial set includes an available slot, as discussed with reference to FIG. 4, or when managing placement of a previously scheduled spot that has been removed in favor of an ad-song advertisement, forward and reverse scheduling techniques can be employed.

As illustrated at block 701, the process for controlling a scheduling order per category can be initiated. Next, as illustrated at block 702, an operation can be processed to identify un-slotted category group positions, theme positions and twofer positions. Thereafter, a test can be performed, as illustrated at block 703, to determine if the un-slotted category group positions, theme positions, and twofer positions have all been identified. If, however, such un-slotted category group positions, theme position, and twofer positions have not been identified in block 702, then an additional test can be performed, as indicated at block 705, to determine whether or not to attempt to identify such data again. If it is determined to make another attempt at identifying such data, then the operation described at block 702 can be processed again, and so on. If, however, as indicated at block 705, it is determined not to make another attempt at identifying such data, then the process terminates, as depicted at block 713.

Assuming that such data has been identified, then un-slotted category group positions, theme positions and twofer positions can be scheduled in reverse order over a given date/time period, as illustrated in block 704. Next, as illustrated at block 706, dayparts can be designated as “Reverse Scheduled”. When scheduling category groups, themes or twofers designated as “Reverse Scheduled” in dayparts, designated as “Reverse Scheduled,” each position in the time range can be scheduled in reverse order, as illustrated in block 708. Next, as illustrated at block 710, a scheduling pass order is retained, followed by retaining the daypart priority pass order, as illustrated in block 712. The process then terminates as illustrated in block 713.

As indicated above, the method 700 for controlling a scheduling order per category can be implemented in the context of a module or group of modules. Such modules include computer implementable instructions for performing instructions including the individual operational steps indicated in the various blocks depicted in FIG. 7. Note that various software applications and implementations may be configured to provide one or more of the instructions illustrated in FIG. 7. One possibility involves configuring a database and associated modules to designate such scheduling control. For example, a bit field may be added to a “StationDayparts” table to designate if a daypart can be reverse scheduled as follows:

```
ALTER TABLE dbo.StationDayparts ADD
      reverseSchedule bit NOT NULL CONSTRAINT
      DF_StationDayparts_reverseSchedule
DEFAULT 0
      Additionally, a new “Pass Order” table, which can store pass
order information regarding Category Groups, Link Categories, Themes
and Twofers, can be configured as follows:
CREATE TABLE [dbo]. [StationPassOrder] (
      [stationID] [int] NOT NULL,
      [entryTypeID] [int] NOT NULL,
      [groupID] [int] NOT NULL,
      [passOrder] [int] NOT NULL,
      [reverseSchedule] [bit] NOT NULL CONSTRAINT
[DF_StationPassOrder_reverseSchedule] DEFAULT ((0)),
CONSTRAINT [PK StationPassOrder] PRIMARY KEY CLUSTERED
(
      [stationID] ASC,
      [entryTypeID] ASC,
      [val] ASC
) WITH (PAD_INDEX=OFF, STATISTICS_NORECOMPUTE = OFF,
IGNORE_DUP_KEY=OFF,
ALLOW_ROW_LOCKS=ON, ALLOW_PAGE_LOCKS =
ON) ON [PRIMARY]) ON [PRIMARY]
```

Additionally, upgrade script can be created in order to copy pass order settings from the StationCategoryGroups table for each Category Group to a StationPassOrder table. The groupID can be to the category group id. Upgrade script can also be created in order to copy the pass order settings from the Stations table for Theme and Twofer to the StationPassOrder table. The groupID can be set to 0. The pass order columns can also be deleted for Theme and Twofer from the Stations table as follows:

```
ALTER TABLE [dbo].[Stations] DROP CONSTRAINT
[DF_stations_twoferPassOrder]
go
ALTER TABLE [dbo].[Stations] DROP COLUMN [twoferPassOrder]
go
ALTER TABLE [dbo].[Stations] DROP CONSTRAINT
[DF_stations_themePassOrder]
go
ALTER TABLE [dbo].[Stations] DROP COLUMN [themePassOrder]
go
Delete the passOrder column from the StationCategoryGroups table
ALTER TABLE dbo.StationCategoryGroups
      DROP CONSTRAINT DF_StationCategoryGroups_passOrder
GO
ALTER TABLE dbo.StationCategoryGroups
      DROP COLUMN passOrder
```

A variety of service designs can be configured in the context of constructing a method and/or system for scheduling per category. For example, a “Pass Order” may be implemented, which provides Read and/or Write techniques with respect to the “StationPassOrder” table discussed earlier. Additionally, such a “Pass Order” allows for inserting, deleting and updating entries, inserting/deleting entries for category groups as they are added/deleted in a particular radio station, and also for inserting/deleting an entry with respect to a twofer when twofers are enabled/disabled. In such a design a reverseSchedule property can be added to the categoryGroup class in schedulerData.cs and populated as category groups are added in the context of a GetcategoryGroups2 method. Additionally, new properties can be populated in the context of a SchedulerContext with the Twofer and Theme scheduling order.

Dayparts can also be configured, which expose the reverseSchedule property from the stationdayparts table in all queries. Such “dayparts” or “DayParts” can also save the reverseSchedule property when updating the stationdayparts table. A reverseSchedule property can be added to a Daypart class in SchedulerData.cs and populate dayparts are added in the context of a GetDaypartData2 method.

Other reverse scheduling aspects may be configured, including the handling of revised properties of stations and stationdayparts table, along with the handling of a new stationpassorder table. Copy and delete station capabilities can also be configured, including the handling of revised properties of stations and stationdayparts tables, along with the handling of new “stationpassorder” tables. Additionally, a “scheduler” can be implemented, including “Next Due” aspects and an “In ScheduleDayinParallel” method.

When both daypart and category groups are ‘reverse schedule’ designated, a call command calcNextDaypartPlay can be implemented instead of calcPriorDaypartPlay. Additionally, local variables can be swapped prior to calling calcDueness as follows Int32 firstSongPosinDaypart and Int32 lastSongPosinDaypart. Additionally, the ‘next play’ can be passed to calcDueness instead of ‘last play’. The operation calcDueness can also be modified to use the absolute difference between the ‘current play’ and the ‘last play’. Regarding the “Hour” and timing, when the both daypart and category group are in a ‘reverse schedule’ mode, a new method (or module) may be written called calcNextHourPlay. Other operations include calling calcNextHourPlay instead of calcPriorHourPlay and swapping the local variables prior to calling calcDuenessinHour as follows: Int32 lastSongPosinHour and Int32 firstSongPosinHour. Additional modifications include ‘pass’ the ‘next play’ to calcDuenessinHour instead of ‘last play’ and modifying calcDuenessinHour to use the absolute difference between the ‘current play’ and the ‘last play’.

Category group positions can be provided by creating a new class OrderedDaypartSegment, derived from DaypartSegment, which has an additional property to identify Forwards or Reverse scheduling and a list of category group ids to be scheduled as follows.

```
class OrderedDaypartSegment : DaypartSegment
{
    enum SchedulingOrder {Forward, Backward}
    List<int> categoryGroupsinSegment
}
```

In LinearPass Method

A calculation of “dueness” as above can occur, which takes into account forward or reverse scheduling to ensure search depth uses correct songs. Additionally, a new list of OrderedDaypartSegments called newDaypartSegsinTimeOrder can be populated and constructed from the DaypartSegments in daypartSegsinTimeOrder and each segment designated as

Forwards. For the daypart in each segment in the range, if the daypart is not ‘Reverse Schedule’ then all the specified category group ids from the catgroupsinpass can be added to the seg.categoryGroupsInSegment. If the daypart is ‘Reverse Schedule’, then only the category group ids from catgroupsinpass which are not ‘Reverse Schedule’ are added to the seg.categoryGroupslnSegment.

Additional OrderedDaypartSegments from the same DaypartSegment can be added in daypartSegsinTimeOrder in reverse order if any of the Category Groups are designated as ‘Reverse Schedule’ and the underlying daypart for the segment is also designated as ‘Reverse Schedule’. These can be marked as Reverse, and the category group id added to the seg.categoryGroupsInSegment. Additional operations including iterating the new list of OrderedDaypartSegment, and instead of the foreach (DaypartSegment seg in daypartSegsinTimeOrder) the following is used: foreach (OrderedDaypartSegment seg in newDaypartSegsinTimeOrder).

Additional instructions including ensuring that songsByStackingTypeAndCatGroup is only populated once per category group and {hour|daypart} by only populating in the Forwards scheduling pass. Also, operations can be implemented to determine a start position, an end position and an increment based on seg.schedOffset, seg.numPositions, seg.schedulingOrder and then iterating over each position in the segment in the desired order instead of always doing so from the beginning to end.

If the orderedDaypartsegment scheduling order is Forwards, then an operation can be processed to iterate over the schedule positions from beginning to end and continue to unschedule the planned songs as before. If the orderedDaypartsegment scheduling order is “Reverse,” then an operation is implemented to iterate over the schedule positions from the end to the beginning, with no unscheduled planned songs.

When identifying if the position to schedule is in the correct category group for the current pass, instead of:

```
if (se.entrytype == EntryType.Song
      && se.status == Status.Unscheduled
      && catgroupsinpass.Contains(se.catgrpid))
```

An operation can be implemented to ensure that the category group is valid for the current orderedDaypartsegment by evaluating the seg.categoryGroupsInSegment instead of catgroupsinpass. Regarding Artist Block Positions, the ‘Reverse Scheduled’ setting can be obtained for Twofers from SchedulerContext. Additionally, a “lookupScheduledArtistBlocks” method can be modified to yield a list of artist block positions based on the reverse schedule setting of unscheduled artist blocks and each daypart in the time range.

Regarding “Twofer Positions,” an operation can be processed to obtain the ‘Reverse Scheduled’ setting for Twofers from SchedulerContext. The “lookupScheduledTwofers” method can be modified to yield a list of twofer positions based on the reverse schedule setting of unscheduled twofers and each daypart in the time range.

Regarding “Theme Positions,” an operation can be processed to obtain the ‘Reverse Scheduled’ setting for Theme from SchedulerContext. A new list of OrderedDaypartSegments can be populated, which is called newDaypartSegsinTimeOrder and constructed from the DaypartSegments in daypartSegsinTimeOrder. The “schedulingOrder” can be then designated as Forwards or Reverse where applicable. Additional operations include iterating over the newDaypartSegsinTimeOrder. If the OrderedDaypartSegment scheduling order is Forwards, then iteration may take place over the schedule positions from beginning to end. If the OrderedDaypartSegment scheduling order is Reverse, then iteration can take place over the schedule positions from the end to the beginning.

In configuring a method and/or system for controlling a scheduling order, as discussed herein, policy information and conditions may be configured. For example, an operation may be implemented to update Policy Schema to handle revised properties of stations and a “stationdayparts” table and a new “stationpassorder” table. New and/or charged data can be propagated in “policy” XML and the “Pass Order” discussed herein can have a dependency on category groups.

Other potential design aspects including modifying the Pass Order by exposing the ‘Reverse Schedule’ property in a pass order dialog, along with pulling the pass order data when opening the pass order dialog, and merging with the pass order information for the category groups, theme and twofer rows. Additional design aspects include preventing slotted categories from being ‘reverse scheduled’ and persisting new pass order data when category data is saved. Regarding “dayparts,” the “Reverse Scheduling” property can be exposed when adding, viewing and/or editing a daypart. Further design aspects including allowing for editing of the ‘Reverse Scheduling’ property in an Add/Edit daypart dialog only.

Note that as utilized herein the term “dialog” refers to a “dialog box,” which is a special feature or window utilized in the context of a GUI (Graphical User Interface), such as, for example, the interface 653 of FIG. 6, to display information to a user, or to obtain a response, if required. A “dialog” refers to a dialog between a data-processing system, such as that described herein with respect to FIGS. 5-6 and the user. The data-processing system informs the user of something, requests input from the user, or both. Such a dialog or dialog box provides controls that allow a user to specify how to carry out a particular action.

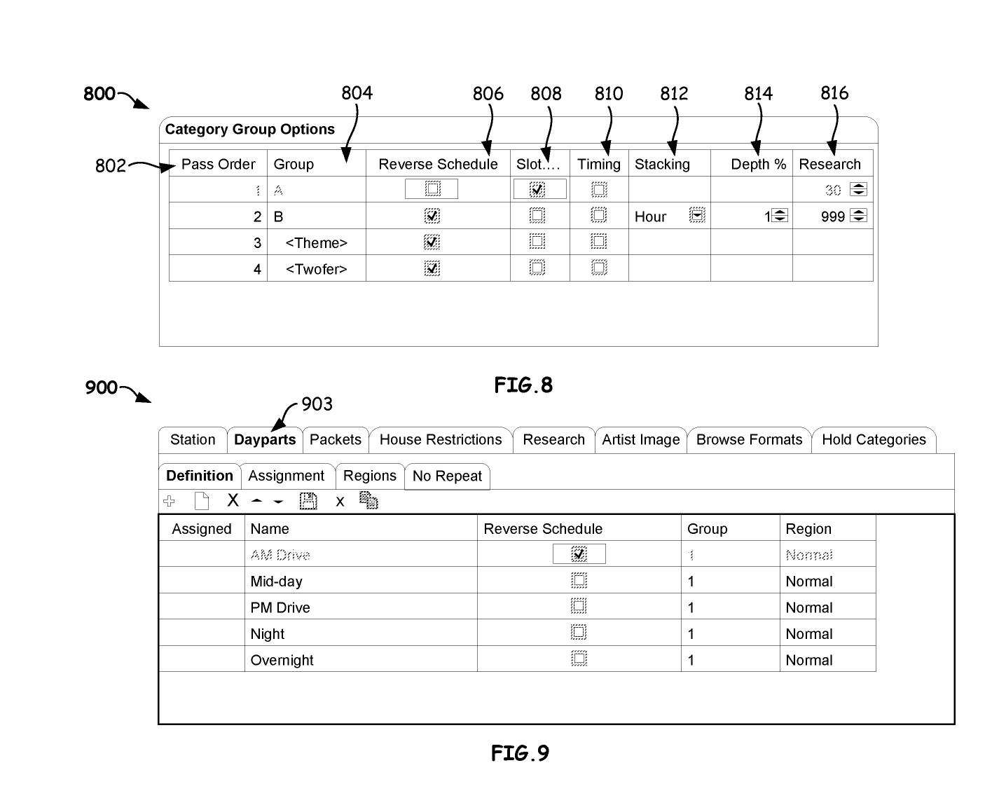

FIG. 8 illustrates an example of a graphically displayed table 800, which may be utilized to configure settings for controlling a multimedia schedule, in accordance with the disclosed embodiments. It can be appreciated that the table 800 can be displayed in the context of a GUI, such as the interface 653 of FIG. 6 for display on a display such as, for example, the display device 506 of FIG. 5. Category group options can be set using table 800. A user can interact with the table 800 to designate, for example, the “Pass Order” with respect to column 802 shown in FIG. 8. Column 804 allows a user to set “Group” options such as designating an “A” or “B” group or a <Theme> or <Twofer>. In some embodiments, a category group option can be used to assign media items to a category of “ad songs,” (not explicitly illustrated). Column 806 allows a user to set “Reverse Schedule” options, while a particular slot may be set using controls within column 808. Additionally, timing options, for example proximity thresholds (not explicitly illustrated), can be set using controls under column 810, and stacking options set using controls under column 812. Depth (percentage) can be set using controls associated with column 814. Finally, research data can be designated using data entered underneath column 816.

FIG. 9 illustrates an example of a graphically displayed table 900, which may be utilized to configure settings for controlling a multimedia schedule, in accordance with the disclosed embodiments. Table 900, in association with table 800, provide a number of options. The most notable option for selection in FIG. 9 is the ability to designate “Dayparts” data and settings, as indicated by the controls associated with the graphically displayed tab 903.

In an embodiment of the disclosed invention, an efficient multimedia scheduling technique intends to optimize the rotation of smaller categories containing multimedia that also appear in pre-scheduled special programming. In a pre-programmed countdown show that airs at 7:00 p.m., for example, songs may be featured that also play in a normally scheduled category. Typically, songs featured in a countdown show are pre-scheduled before the scheduler, or scheduling module of a computer-implemented device, schedules the programming for the preceding time slots. This can lead to compromised rotations of those songs as the scheduler attempts to work around the rotation problem.

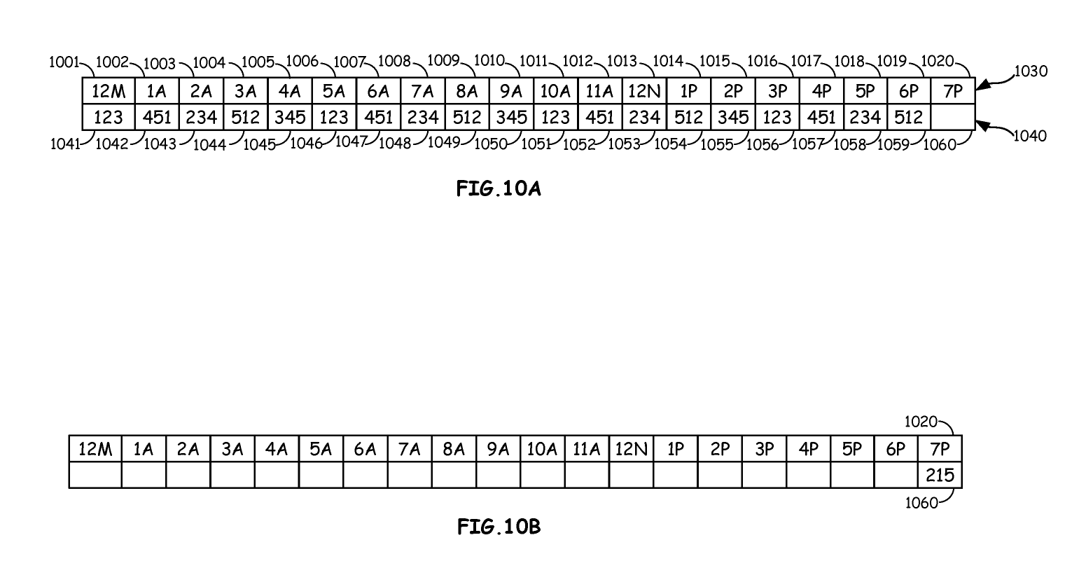

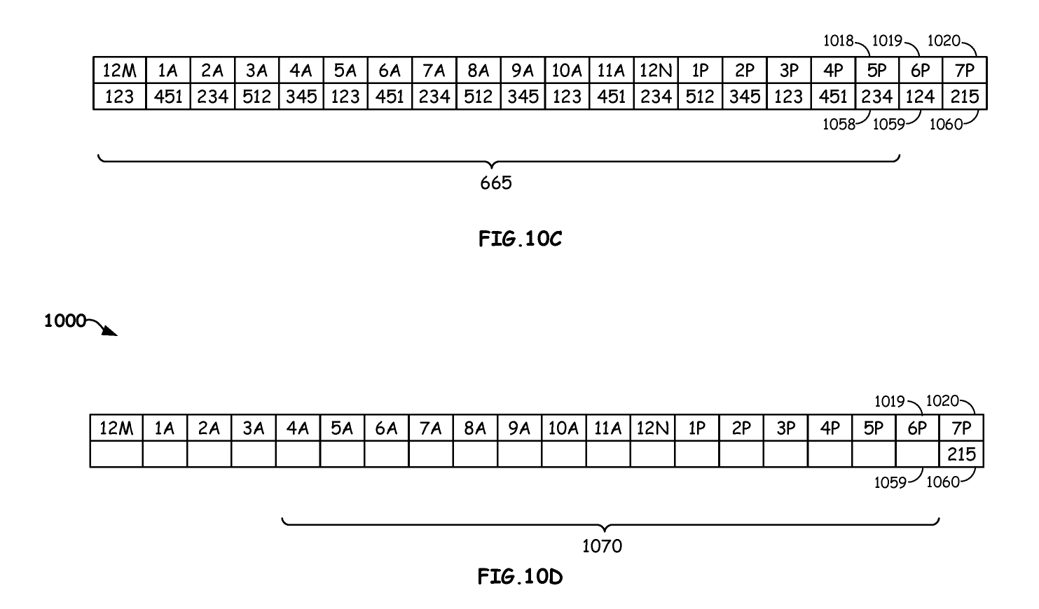

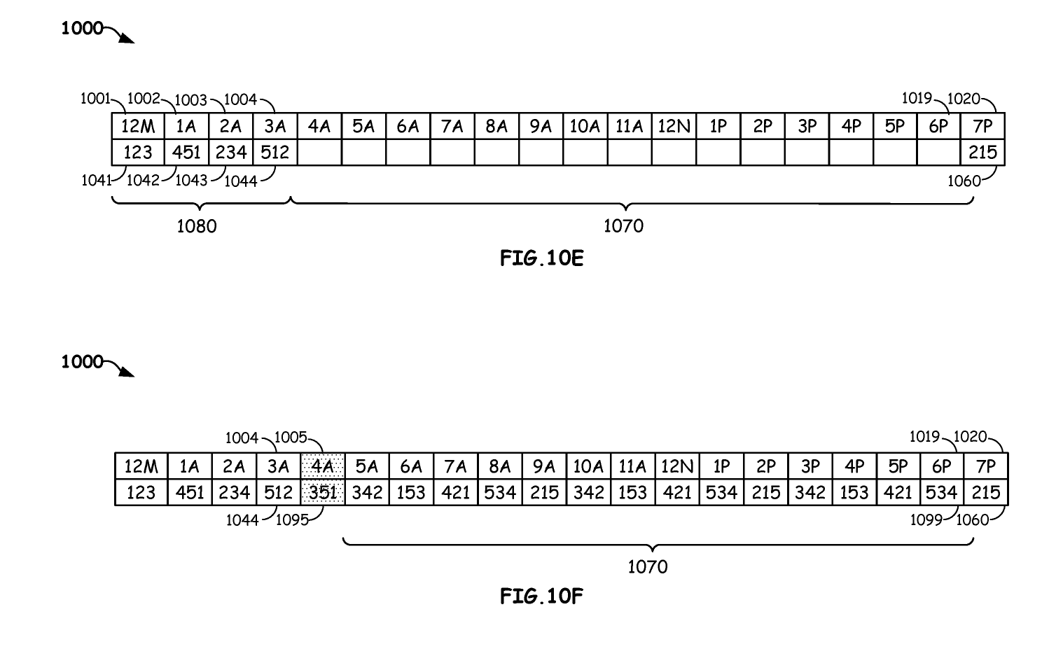

FIG. 10A illustrates an example of a multimedia programming rotation with evenly-spaced plays throughout a programming day. Each column illustrates the programming rotation of three songs out of a rotation of five songs (each song numbered 1 through 5) per hour-long time slot, beginning with 12:00 midnight 1001 and ending with 7:00 p.m. 1020. The top row 1030 shows the day's particular time slot 1001 through 1020, beginning with 12:00 midnight and ending with 7:00 p.m. and the bottom row 1040 shows the combination 1041-1060 of three particular songs out of five total songs in a category chosen for that particular time slot. FIG. 10A illustrates how five songs in a single category would be equally rotated with three clock requests each hour for that category. In the 12:00 midnight time slot 1001, for example, the combination 1041 of songs 1-2-3 is scheduled to air. In the next time slot 1002, the combination 1042 of songs 4-5-1 is scheduled to air. The song pattern of 1-2-3-4-5 repeats until the scheduling pattern ceases following the 6:00 p.m. hour 1019, or just before for the pre-programmed show at 7:00 p.m. 1020. As an ideal rotation, the five songs in a single category are equally spread and get even play in the program throughout the day, beginning at 12:00 midnight 1001 and ending at 6:00 p.m. 1019, before the start of the 7:00 pm. countdown show.

This ideal rotation, however, can be interrupted depending on the songs scheduled to air during the pre-programmed countdown show. FIG. 10B illustrates the three songs scheduled 1060 to be played in the 7:00 time slot 1020 during a pre-programmed countdown show. Songs 2-1-5 are pre-programmed, or scheduled 1060 in this order into the schedule during the 7:00 p.m. time slot 1020.

In FIG. 10C, with the countdown show songs (2-1-5) in the 7:00 p.m. time slot 1012, the remaining time slots throughout the day are scheduled 665. The five songs, however, are not evenly-spread throughout the day's programming when manual scheduling begins at the beginning of the day at the 12:00 midnight time slot 1001 when the 7:00 p.m. time slot 1060 is already pre-programmed. In the 6:00 p.m. time slot 1019, songs 2-1-5 would be ideal choices based on the previous time slot's schedule, as illustrated in 1059 in FIG. 10A. But, songs 2-1-5 have already been scheduled 1060 for the 7:00 p.m. countdown show. The scheduler has to make serious compromises to the rotational pattern, thus having to settle with songs 1-2-4 1069 in the 6:00 p.m. time slot 1019. Scheduling songs 1-2-4 1069 in the 6:00 p.m. time slot 1019 results in songs 2 and 4 having poor spread due to their play in the previous 5:00 p.m. time slot 1018. There are very few ways to resolve the scheduling problem when the countdown show is pre-programmed and the rest of the day's programming is set starting at the beginning of the day.

FIG. 10D illustrates a time slot range 1070 in which a reverse scheduling method 1000 is used to solve scheduling problems as described in FIGS. 10A-10C. Reverse scheduling, as illustrated in FIG. 10D works by scheduling a day's programming from the reverse direction, starting immediately before the pre-programmed show. The scheduler provides a time slot range 1070 in which day's programming is to be scheduled in reverse chronological order, preventing rotation problems with pre-scheduled programming. For example, in FIG. 10E, the countdown show is again scheduled at 7:00 p.m. 1020, with songs 2-1-5 pre-programmed/scheduled 1060. The time slot range 1080 from 12:00 midnight to 3:00 a.m. 1004 is scheduled in regular chronological order, as shown in FIG. 10E, as this range is an off-peak time slot range.

In FIG. 10F, the time slot range from 5:00 a.m. 1005 to 6:00 p.m. 1019 is scheduled in reverse chorological order to prevent rotation problems between the countdown show in the 7:00 p.m. time slot and the time slots immediately preceding the show. The scheduler or a computer-implemented scheduling module starts at 6:00 p.m. 1019 and looks both ahead in time and behind in time to make the best scheduling choices. When starting with the 6:00 p.m. hour 1019, the scheduler finds that songs 2-1-5 1060 are closest to the songs in the pre-scheduled countdown show in the 7:00 p.m. time slot 1020. The scheduler then avoids scheduling this song combination of 2-1-5 in the 6:00 p.m. time slot. Because one song out of this three song combination must be used in the 6:00 p.m. time slot 1019, the scheduler module chooses song 5 to schedule in the 6:00 p.m. time slot, in the farthest position from the rotation in the 7:00 p.m. time slot. Scheduling song 5 in the first position in the 6:00 p.m. time slot provides the most separation from the song 5's play in the pre-scheduled 7:00 p.m. time slot.

Looking back in time, the scheduler sees that songs 3 and 4 are played, in that order, in the 2:00 a.m. time slot. To keep songs 3 and 4 as separate as possible for a proper rotation, the scheduler places songs 3 and 4, in that order, in the remaining two positions in the 6:00 p.m. time slot. The final order of songs in the 6:00 p.m. time slot 1019 is 5-3-4 699. The scheduler then works in reverse chronological order from the 6:00 p.m. time slot 1019, essentially repeating the established pattern to schedule the remaining time slots and prevent scheduling problems with pre-programmed show at 7:00 p.m. 1020.

The reverse scheduling method 1000 disclosed herein allows a scheduler to prevent scheduling problems during peak rotation hours, by burying rotational compromises in off-peak hours. In FIG. 10F, for example, following performance of the reverse scheduling method 1000, the established scheduling pattern must be broken in the 4:00 a.m. time slot 1005 because of scheduling conflicts in the 3:00 a.m. time slot. Following the reverse chronological scheduling pattern, the 4 a.m. time slot 1005 should be programmed with songs 2-1-5, in that order. In the 3:00 a.m. time slot 1004, however, songs 5-1-2 are already scheduled 1044 in that order. The scheduler must compromise the rotation schedule in the off-peak 4:00 a.m. time slot, and schedule combination 1095 of songs 3-5-1 instead. However, there are fewer listeners in this hour as compared to the 6:00 p.m. time slot. By properly constructing a reverse scheduling region, the user can now “bury” the scheduling compromise at a time where any negative impact on the rotation will affect far fewer listeners than the number who would have been affected by poor rotation in the 6:00 p.m. time slot.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments of an invention have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples of the invention. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module includes a processing module, a processor, a functional block, hardware, and/or memory that stores operational instructions for performing one or more functions as may be described herein. Note that, if the module is implemented via hardware, the hardware may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure of an invention is not limited by the particular examples disclosed herein and expressly incorporates these other combinations.

What is claimed is:

1. A method for use in an automated media scheduling system, the method comprising:
performing a first evaluation of a media programming log, by executing a program instruction in a data processing apparatus;
determining, based on the first evaluation, that an ad song associated with an advertiser is scheduled for broadcast within a proximity threshold of a commercial set, by executing a program instruction in a data processing apparatus;
performing a second evaluation of a spot inventory associated with the commercial set, by executing a program instruction in a data processing apparatus;
determining, based at least in part on the second evaluation, that at least one spot in the commercial set can be used for insertion of an ad-song advertisement containing at least a portion of a version of the ad song in response to evaluating the spot inventory, wherein the ad-song advertisement is associated with the advertiser, by executing a program instruction in a data processing apparatus;
inserting the ad-song advertisement in the at least one spot of a broadcast log; and
delivering the broadcast log to an audio server.

2. The method of claim 1, wherein determining that at least one spot in the commercial set is available to be used for insertion of the ad-song advertisement includes:
determining, based on the second evaluation, that a previously scheduled advertisement associated with the advertiser is available to be replaced by the ad-song advertisement, by executing a program instruction in a data processing apparatus; and
wherein inserting the ad-song advertisement includes removing the previously scheduled advertisement from the at least one spot, by executing a program instruction in a data processing apparatus.

3. The method of claim 1, wherein determining that at least one spot in the commercial set is available to be used for insertion of the ad-song advertisement includes:
determining, based on the second evaluation, that an unscheduled spot is available for placement of the ad-song advertisement, by executing a program instruction in a data processing apparatus.

4. The method of claim 1, further comprising:
transmitting a notification to a traffic system, the notification including information indicating that the ad-song advertisement has been inserted, by executing a program instruction in a data processing apparatus.

5. The method of claim 1, wherein determining that at least one spot in the commercial set is available to be used for insertion of the ad-song advertisement includes:
determining, based on the second evaluation, that a previously scheduled advertisement associated with a different advertiser can be replaced by the ad-song advertisement, by executing a program instruction in a data processing apparatus;
substituting the ad-song advertisement for the previously scheduled advertisement, by executing a program instruction in a data processing apparatus; and
attempting to reschedule the previously scheduled advertisement, by executing a program instruction in a data processing apparatus.

6. The method of claim 1, further comprising:
storing an ad-song tag in metadata associated with the ad song, by executing a program instruction in a data processing apparatus; and
wherein the first evaluation of the media programming log is based, at least in part, on evaluating the ad-song tag, by executing a program instruction in a data processing apparatus.

7. The method of claim 1, further comprising:
storing an ad-song advertisement tag in metadata associated with the ad-song advertisement, by executing a program instruction in a data processing apparatus; and
wherein the second evaluation of the media programming log is based, at least in part, on evaluating the ad-song advertisement tag.

8. The method of claim 1, further comprising:
performing the operations of claim 1 for both a terrestrial broadcast and an on-line broadcast.

9. The method of claim 1, further comprising:
performing the operations of claim 1 after content ingest and traffic load processes.

10. An automated media scheduling system comprising:
a processing device including a processor and associated memory, the processing device configured to implement a database server;
at least one processing device including a processor and associated memory configured to implement a traffic system, the traffic system coupled to the database server, and configured to provide to the database server with information about advertiser orders;
the database server configured to:
perform a first evaluation of a media programming log based at least in part on the information about advertiser orders;
determine, based on the first evaluation, that an ad song associated with an advertiser is scheduled for broadcast within a proximity threshold of a commercial set;
perform a second evaluation of a spot inventory associated with the commercial set;
determine, based at least in part on the second evaluation, that at least one spot in the commercial set can be used for insertion of an ad-song advertisement containing at least a portion of a version of the ad song in response to evaluating the spot inventory, wherein the ad-song advertisement is associated with the advertiser, by executing a program instruction in a data processing apparatus;
insert the ad-song advertisement in the at least one spot of a broadcast log; and
deliver the broadcast log to an audio server.

11. The automated media scheduling system of claim 10, wherein the database server is further configured to:
determine, based on the second evaluation, that a previously scheduled advertisement associated with the advertiser is available to be replaced by the ad-song advertisement; and
remove the previously scheduled advertisement from the at least one spot.

12. The automated media scheduling system of claim 10, wherein the database server is further configured to:
determine, based on the second evaluation, that an unscheduled spot is available for placement of the ad-song advertisement.

13. The automated media scheduling system of claim 10, wherein the database server is further configured to:
transmit a notification to the traffic system, the notification including information indicating that the ad-song advertisement has been inserted.

14. The automated media scheduling system of claim 10, wherein the database server is further configured to
determine, based on the second evaluation, that a previously scheduled advertisement associated with a different advertiser can be replaced by the ad-song advertisement;
substitute the ad-song advertisement for the previously scheduled advertisement; and
attempt to reschedule the previously scheduled advertisement.

15. The automated media scheduling system of claim 10, wherein the database server is further configured to:
store an ad-song tag in metadata associated with the ad song;
perform the first evaluation of the media programming log based, at least in part, on evaluating the ad-song tag;
store an ad-song advertisement tag in metadata associated with the ad-song advertisement; and
perform the second evaluation of the media programming log based, at least in part, on evaluating the ad-song advertisement tag.

16. A method for use in an automated media scheduling system, the method comprising:
performing a first evaluation of a media programming log to identify an ad song associated with an advertiser, the ad song scheduled for broadcast within a proximity threshold of a commercial set, by executing a program instruction in a data processing apparatus, wherein the first evaluation is performed, at least in part, based on an ad-song tag associated with a scheduled song listed in the media programming log;
performing a second evaluation of a spot inventory associated with the commercial set, by executing a program instruction in a data processing apparatus;
determining, based at least in part on the second evaluation, that at least one spot in the commercial set can be used for insertion of an ad-song advertisement containing at least a portion of a version of the ad song in response to evaluating the spot inventory, wherein the ad-song advertisement is associated with the advertiser, by executing a program instruction in a data processing apparatus;
inserting the ad-song advertisement in the at least one spot of a broadcast log; and
delivering the broadcast log to an audio server.

17. The method of claim 16, further comprising:
performing the operations of claim 16 after content ingest and traffic load processes.

18. The method of claim 16, further comprising:
transmitting a notification to a traffic system, the notification including information indicating that the ad-song advertisement has been inserted, by executing a program instruction in a data processing apparatus.

19. The method of claim 16, wherein determining that at least one spot in the commercial set is available to be used for insertion of the ad-song advertisement includes:
determining, based on the second evaluation, that a previously scheduled advertisement associated with the advertiser is available to be replaced by the ad-song advertisement, by executing a program instruction in a data processing apparatus; and
wherein inserting the ad-song advertisement includes removing the previously scheduled advertisement from the at least one spot, by executing a program instruction in a data processing apparatus.

20. The method of claim 16, wherein determining that at least one spot in the commercial set is available to be used for insertion of the ad-song advertisement includes:
determining, based on the second evaluation, that a previously scheduled advertisement associated with a different advertiser can be replaced by the ad-song advertisement, by executing a program instruction in a data processing apparatus;
substituting the ad-song advertisement for the previously scheduled advertisement, by executing a program instruction in a data processing apparatus; and
attempting to reschedule the previously scheduled advertisement, by executing a program instruction in a data processing apparatus.
